(19) United States
(12) Patent Application Publication
(10) Pub. No.: US 2006/0108053 A1
(43) Pub. Date: May 25, 2006

(54) Hot application of apex on a tire building machine

(76) Inventors: James Michael Hart, Akron, OH (US); Gary Robert Burg, Massillon, OH (US); John Kolbjoern Roedseth, Bissen (LU); Marie-Laure Benedicte Josette Cavalotti, Nusbaum (DE)

Correspondence Address: Howard M. Cohn, Suite 220, 21625 Chagrin Blvd., Cleveland, OH, 44122, US

(21) Appl. No.: 10/994,015

(22) Filed: Nov. 19, 2004

(51) Int. Cl. B29D 30/32

(52) U.S. Cl. 156/131; 156/132; 156/136; 156/398

(57) ABSTRACT

Method and apparatus for applying an apex at a workstation of a pneumatic tire building machine wherein a carcass reinforcement ply and one or more bead area components have been built into an in-process carcass on a tire building drum of the tire building machine. An injector-extruder is located at the workstation, and is either configured to extrude hot apex material directly into a bead area of the in-process carcass on the tire building drum, or to extrude the hot apex material onto an application drum followed by applying a hot apex from the application drum into a bead area of the in-process carcass on the tire building drum.

### TECHNICAL FIELD OF THE INVENTION

The present invention relates to pneumatic tire building and, more particularly to the application of a bead area filling apex during tire building.

### BACKGROUND OF THE INVENTION

During the building of pneumatic tires, it is common practice to apply uncured elastomeric filler material in the bead area, typically radially outward from the bead core, in order to provide a smoothly tapered transition from the relatively thick bead area to the typically thinner sidewall. In so doing, the filler material, termed an “apex” (or more specifically for this usage a “bead apex”), prevents trapped air pockets from forming in the transition area. Current tire building practice is to pre-form the apex in a long, somewhat triangular strip that is either precut to a required length, or may be a long continuous strip that is wound on a supply reel. Subsequently the apex is supplied to the tire building machine where the apex is wrapped around the carcass in the bead area, “stitched” (pressed) in place, and cut to length if necessary. Some tire building machines utilize an intermediary “false drum” wherein the apex is first supplied to and wrapped around the false drum, cut to length, and then transferred from the false drum to the carcass on a tire building drum by rolling the false drum against the building drum, thereby stitching the apex to the carcass. It is also known to bond an apex to a bead core in a separate operation before the bead core is applied to the carcass on the tire building machine.

A common feature of the known apex application methods is that the apex is pre-formed (typically by extruding) in a separate operation at a different location from the tire building machine and at an earlier time (typically much earlier) than when the pre-formed apex is eventually applied to a carcass during the tire building operation. Another common feature is the use of significantly high pressure for stitching the apex to the carcass, the high pressure being required to re-shape the pre-formed apex to conform to bead area contours such that gaps are filled and air pockets are eliminated.

Some tire constructions have complex contours in the bead area and/or have multiple bead cores or other relatively rigid bead area components such that re-shaping the apex to fill all gaps may require stitching pressures high enough to potentially move bead area components on the building drum, thereby potentially creating tire non-uniformities that will negatively impact tire performance. It is an object of this invention to overcome this problem related to apex application at a tire building machine.

### BRIEF SUMMARY OF THE INVENTION

According to the invention a method is disclosed for applying an apex at a workstation of a pneumatic tire building machine wherein a carcass reinforcement ply and one or more bead area components have been built into an in-process carcass on a tire building drum of the tire building machine, the method characterized by the step of extruding hot apex material to form the apex at the workstation.

According to the invention the method is further characterized by the step of extruding into a bead area of the in-process carcass on the tire building drum. Preferably this method is further characterized by the steps of: firstly laying a carcass reinforcement ply on the tire building drum; secondly applying a first bead area component that is a rubber wedge; thirdly wrapping a turnup portion of the carcass reinforcement ply around the rubber wedge; fourthly applying a second bead area component that is an inextensible bead core onto the turnup portion axially inward of the rubber wedge; fifthly expanding the tire building drum; and sixthly performing the extruding step.

According to the invention the method is further characterized by the steps of: extruding the hot apex material onto an application drum; and applying a hot apex from the application drum into a bead area of the in-process carcass on the tire building drum. Preferably, this method is further characterized by the steps of: firstly laying a carcass reinforcement ply on the tire building drum; secondly applying a first bead area component that is a rubber wedge; thirdly wrapping a turnup portion of the carcass ply around the rubber wedge; fourthly applying a second bead area component that is an inextensible bead core onto the turnup portion axially inward of the rubber wedge; fifthly expanding the tire building drum; and sixthly performing the step of applying the hot apex from the application drum into the bead area of the in-process carcass on the tire building drum.

According to the invention, a tire building machine including a tire building drum is disclosed, the tire building machine characterized by an apex-forming injector-extruder for extruding hot apex material. Preferably, the tire building machine is further characterized in that the injector-extruder is configured for extruding hot apex material onto the tire building drum, or alternatively, the tire building machine is further characterized by an application drum configured for transferring a hot apex onto the tire building drum; and wherein the injector-extruder is configured for extruding the hot apex onto the application drum.

According to the invention, an apex applicator is disclosed for a first stage tire building machine including a tire building drum at a workstation, the apex applicator characterized by: an apex-forming injector-extruder for extruding hot apex material, wherein the apex applicator is located at the workstation. Preferably, the apex applicator is further characterized in that the injector-extruder is configured for extruding hot apex material onto the tire building drum, or alternatively, the apex applicator is further characterized by an application drum configured for transferring a hot apex onto the tire building drum; and wherein the injector-extruder is configured for extruding the hot apex onto the application drum.

Other objects, features and advantages of the invention will become apparent in light of the following description thereof.

### BRIEF DESCRIPTION OF THE DRAWINGS

Reference will be made in detail to preferred embodiments of the invention, examples of which are illustrated in the accompanying drawing figures. The figures are intended to be illustrative, not limiting. Although the invention is generally described in the context of these preferred embodiments, it should be understood that it is not intended to limit the spirit and scope of the invention to these particular embodiments.

Certain elements in selected ones of the drawings may be illustrated not-to-scale, for illustrative clarity. The cross-sectional views, if any, presented herein may be in the form of “slices”, or “near-sighted” cross-sectional views, omitting certain background lines which would otherwise be visible in a true cross-sectional view, for illustrative clarity.

Elements of the figures can be numbered such that similar (including identical) elements may be referred to with similar numbers in a single drawing. For example, each of a plurality of elements collectively referred to as 199 may be referred to individually as 199a, 199b, 199c, etc. Or, related but modified elements may have the same number but are distinguished by primes. Such relationships, if any, between similar elements in the same or different figures will become apparent throughout the specification, including, if applicable, in the claims and abstract.

The structure, operation, and advantages of the present preferred embodiment of the invention will become further apparent upon consideration of the following description taken in conjunction with the accompanying drawings, wherein:

FIG. 1 is a cross-sectional view of a portion of a self-supporting run-flat tire, particularly showing an apex and a bead area, according to the invention;

FIG. 2 is a schematic top view of a first stage tire building system, according to the invention;

FIG. 3A is a schematic side view of a workstation of the first stage tire building system of FIG. 2, particularly showing an application drum interacting with a supply reel, according to the invention;

FIG. 3B is a schematic side view of the workstation of FIG. 2, particularly showing a tire building drum interacting with the application drum, according to the invention;

FIG. 4A is a cross-sectional view of a portion of one edge of the tire building drum and tire components that have been built thereupon (shading omitted for clarity), particularly showing the bead area of the tire of FIG. 1 in a first stage of building, according to the invention;

FIG. 4B is a cross-sectional view as in FIG. 4A, but particularly showing the bead area in a second stage of building wherein portions of the bead area are turned up, according to the invention;

FIG. 4C is a cross-sectional view as in FIG. 4A, but particularly showing the bead area in a third stage of building wherein a bead core is positioned, according to the invention;

FIG. 4D is a cross-sectional view as in FIG. 4A, but particularly showing the bead area in a fourth stage of building wherein the tire building drum is expanded for shaping the bead area in preparation for application of an apex, according to the invention;

FIG. 5A is a side view of a tire building drum interacting with an injector-extruder, shown in partial cross-section, according to the invention; and

FIG. 5B is a side view of the application drum of FIG. 3A interacting with the injector-extruder, according to the invention.

### DETAILED DESCRIPTION OF THE INVENTION

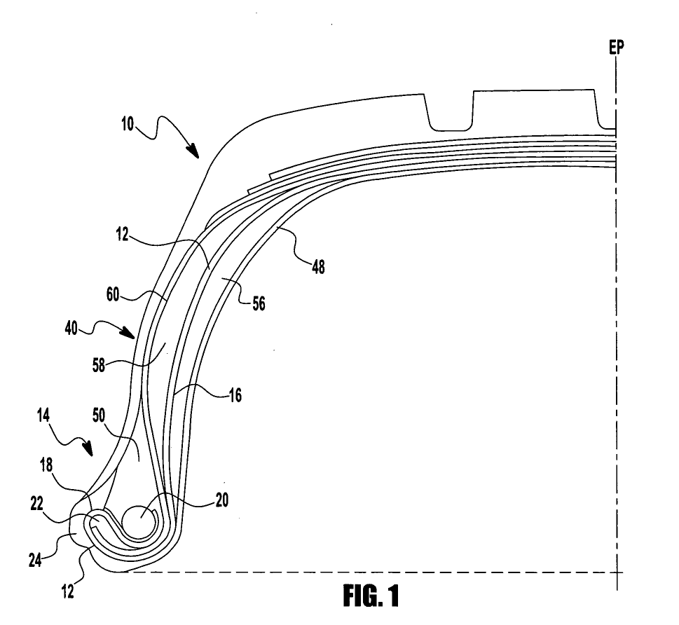

Although the present invention has broad applicability, it will be described in the context of a particular embodiment of tire construction generally known as a run-flat tire, or an extended mobility tire (EMT). FIG. 1 illustrates a particular type of EMT that is a self-supporting tire 10. Although only half of the cross-sectional view of the tire 10 is shown (bounded by an equatorial plane EP), it will be understood by those skilled in the art that the opposing, non-illustrated tire half may be identical to that illustrated, at least insofar as the bead area construction is concerned. The pneumatic tire 10 has a carcass comprising a carcass reinforcement ply 12 that extends from one bead area 14 to an opposing bead area 14 (not shown). The carcass reinforcement ply 12 has a main portion 16 extending about the main toroidal portion of the tire 10. Turn-up portions 18 of the carcass reinforcement ply 12 are the outer ends of the reinforcement ply 12 that extends radially inward and axially outward under (axially inward of) an inextensible bead core 20, then turns radially outward and folds back axially inward to pass again under the bead core 20, such that the end of the turn-up portion 18 is sandwiched between the bead core 20 and the main portion 16 of the carcass reinforcement ply 12. To maintain the profile of the turn-up portion 18 as the ply 12 folds back under the bead core 20, the turn-up portion 18 folds about a hard rubber wedge 22 located axially outward of the bead core 20. A toe 24 forms an axially outward portion of the bead area 14.

During building of the tire 10 on a tire building drum, a first elongated insert 56 is applied in a sidewall region 40 outward of a tire innerliner 48 and prior to application of the carcass reinforcement ply 12. After the primary carcass reinforcement ply 12 is wound onto the building drum but is not yet turned about the rubber wedge 22, a second elongated insert 58 is applied. A short length carcass reinforcement ply 60 is laid outward of the second elongated insert 58. The rubber wedge 22 is then laid on the ends of the reinforcement plies 12, 60, the turnup portion 18 of the primary carcass reinforcement ply 12 is wrapped about the rubber wedge 22, and then the bead core 20 is applied to lock in the end of the turnup portion 18. In this manner, the ends of the short carcass reinforcement ply 60 and the radially inner end of the axially outer elongated insert 58 are secured between the main portion 16 and the turnup portion 18 of the primary carcass reinforcement ply 12.

Thus the bead area 14 of the exemplary tire 10 is a fairly complicated construction of bead area components including an inextensible bead core 20, a hard rubber wedge 22, and at least one ply 12 with a turnup portion 18 that follows a serpentine path among the other bead area components in the bead area 14. To fill in the gaps, and to provide a pillar-like sidewall profile that is desired for this particular EMT embodiment of tire 10, a roughly triangular apex 50 is applied in the bead area. Once it is cured, the apex 50 will have certain stiffness requirements that allow it to cooperate with the first elongated insert 56 and the second elongated insert 58 in making the tire “self-supporting”. As will be seen in the following detailed disclosure of the inventive tire building process, application of a relatively stiff, pre-formed apex is likely to cause tire uniformity problems by potentially shifting the relative positions of the various bead area components 12, 18, 20, 22 as the apex 50 is positioned, stitched, and then deformed as the tire carcass is expanded into a toroidal shape.

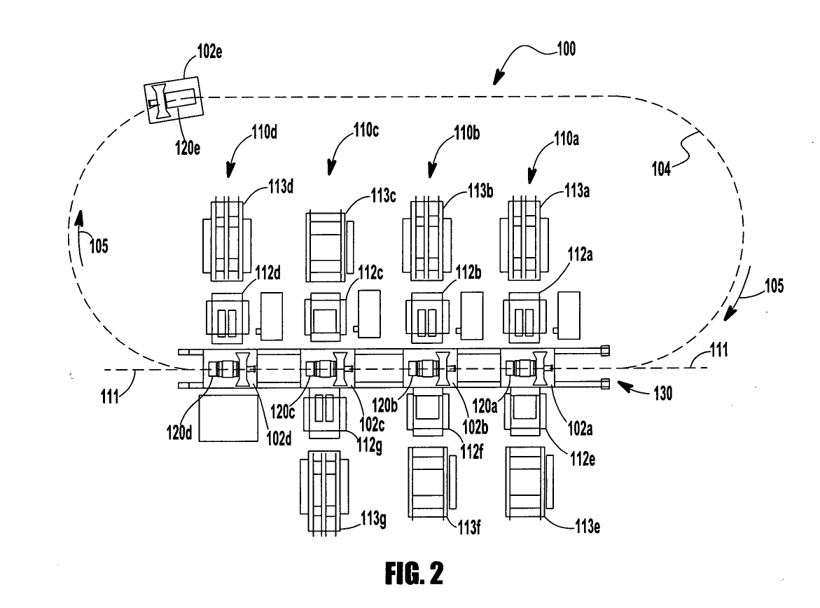

Although the present invention has broad applicability to a variety of automated or manual first stage tire building systems wherein a green tire carcass is “built” by applying tire components on a tire building drum, the invention will be described in the context of a particular embodiment of tire building system that is automated. FIG. 2 shows a first stage tire building system 100 (a flexible manufacturing system) having a plurality of work stations, and a plurality of tire building drums that are propelled into and out of each work station such that tire building operations are performed in proper sequence on a given tire building drum as it proceeds through a first work station, a second work station, and so on through a last work station.

As illustrated for a preferred embodiment of a first stage tire building system 100, a plurality of self-powered automatic guided vehicles (AGVs) 102a, 102b, 102c, 102d, 102e (collectively called “102”) move corresponding tire building drums 120a, 120b, 120c, 120d, 120e (collectively called “120”) through a plurality of work stations 10a, 110b, 110c, 110d (collectively called “110”), in the direction shown by arrows 105. The AGVs 102 follow a path determined by a guide wire 104 embedded in the plant floor, shown in FIG. 2 as an oval path passing through the work stations 110 from a first work station 110a to a last work station 10d, then looping back around to the first work station 110a. The work stations 110 are aligned to, and spaced along, a common, linear working axis 111, and the AGV guide wire 104 is approximately parallel to the working axis 111 where the guide wire 104 passes through the work stations 110. Also parallel to the working axis 111 and passing through the work stations 110 is a rail system 130 for providing precision alignment of the tire building drums 120 with the working axis 111. Each work station 110 comprises one or more application drums 112a, 112b, 112c, 112d, 112e, 112f, 112g (collectively called “112”), and one or more supply reels 113a, 113b, 113c, 113d, 113e, 113f, 113g (collectively called “113”). The application drums 112 are also known as false drums 112 wherein, for example, a tire component is supplied by the supply reel 113 and applied to the false drum 112 which in turn rolls against the tire building drum 120 in order to apply by transfer the tire component on the tire building drum 120.

An exemplary sequence of operations for the first stage tire building FMS 100 can be as follows, wherein a green tire carcass is built for the exemplary run-flat tire 10 described above with reference to FIG. 1. For the first step of a green tire carcass building process, the AGV 102a moves an empty tire building drum 120a into the first work station 110a and stops approximately at a desired stopping point within the first work station 110a where the tire building drum 120a is precisely positioned relative to the first work station 110a. Then first station application drum(s) 112a, 112e can apply the first layer(s) of tire components, pulling the components from their supply reel(s) 113a, 113e. Thus, in the first work station 11a, one innerliner 48 and two toes 24 are pulled from the supply reels 113e and applied by the application drums 112e, and then a pair of first inserts 56 are pulled from the supply reels 113a and applied by the application drums 112a. In the second work station 110b, one carcass ply 12 is pulled from the supply reel 113f and applied by the application drum 112f, and then a pair of second inserts 56 are pulled from the supply reels 113b and applied by the application drums 112b. In the third work station 110c, one short carcass reinforcement ply 60 is pulled from the supply reel 113c and applied by the application drum 112c, and then a pair of rubber wedges 22 are pulled from the supply reels 113g and applied by the application drums 112g. Then, in an operation that will be described in more detail hereinbelow, the turnup portions 18 are wrapped around their respective rubber wedges 22 and the two bead cores 20 are applied on top of the wrapped turnup portions 18. Finally, the conventional prior art manufacturing process steps include pulling a pair of apexes 50 from another pair of supply reels 113g and then using another pair of application drums 112g to apply the pair of apexes 50 to the carcass on the tire building drum 120. In the fourth work station 110d, a pair of sidewalls 40 and chafers are pulled from the supply reels 113d and applied by the application drums 112d. After completion of the application of tire components in the last work station 110d, the built green tire carcass may be removed from the tire building drum 120 for further processing in subsequent tire manufacturing stages (not shown), thus emptying the tire building drum 120 so that it may be moved by the AGV 102 back around the path of the guide wire 104, ready to start another green tire carcass building process in the first work station 110a. Of course the above description is only one example of many different possible arrangements of workstations 110 and the tire building operations that are effected at each workstation 110.

It is important to note the use of supply reels 113, wherein the tire component that is coiled on a supply reel 113 is generally a long length of the component that has been manufactured and coiled on the supply reel 113 at another location, potentially even in a different building. Thus the conventional method of applying an apex 50 generally involves extruding a long length of thus pre-formed rubber apex stock which is coiled on a supply reel 113 in a first location. A quantity of supply reels 113 with long lengths of preformed apex stock are then transported to a second location where the first stage tire building system 100 is located, the reels 113 possibly being delayed in a storage area somewhere in between. Then, as needed, the supply reels 113 are positioned for use by the first stage tire building system 100 wherein the preformed apex stock is un-reeled from the supply reel 113 and cut off at a length that is suitable for the tire 10 that is being built. In other known first stage tire building operations, both automated and manual, the apex 50 is supplied as long stock or as precut lengths to the application drum 112 and/or the tire building drum 120 via reels or conveyors or pallets, etc., but a common characteristic of prior art methods is that the apex 50 is pre-formed at a different location than the tire building drum 120 (and the application drum 112, if used). Thus the prior art methods deliver the apex 50 to the tire building drum 120 in a cold somewhat hardened condition that is suitable for transporting on a conveyor, a pallet, etc. and/or coiling on a supply reel 113 or other supply means.

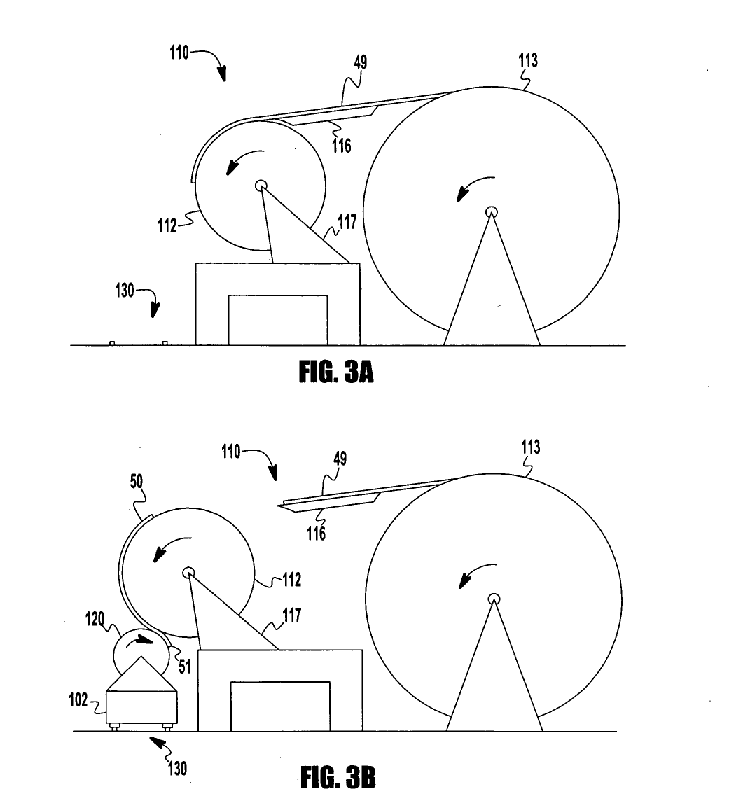

FIGS. 3A and 3B illustrate one such conventional apex application process in a simplified schematic view of a work station 110. FIG. 3A shows a transfer process wherein preformed apex stock 49 is being unreeled from a supply reel 113, and transferred by a conveyor 116 to the surface of an application drum 112. The application drum 112 is mounted on a traversing support 117 that is retracted away from the rail system 130 such that the application drum 112 will not interfere with the movement of AGVs 102 along the rail system 130. The transfer process is performed at a relatively slow speed such that the conveyor 116 can accurately position the apex stock 49 on the application drum 112, and can also accurately cut the apex stock 49 when a predetermined apex length has been transferred to the application drum 112. There is adequate time for this slow transfer process while AGVs 102 are moving and/or when other operations are being performed (e.g., application of another tire component by a different application drum 112).

FIG. 3B shows an application process wherein the apex 50 has been cut to length, an AGV 102 has moved into position at the workstation 110, the tire building drum 120 (with other tire components, not shown, already built thereupon) has been precisely positioned relative to the work station 110, and the traversing support 117 has extended the application drum 112 such that a leading end 51 of the apex 50 has been pressed against the tire building drum 120 by the application drum 112. This results in sticking the leading end 51 onto the tire building drum 120, after which the traversing support 117 can retract slightly, and then the apex 50 is wrapped around the tire building drum 112 by synchronized rotation of the application drum 112 and the tire building drum 120. This application process can be performed at a relatively high speed while still maintaining accurate placement of the apex 50 because of the accurate positioning of the apex 50 on the application drum 112. This helps the overall machine speed for the first stage tire building system 100 by minimizing the amount of time that an AGV 102 must spend in a work station 110.

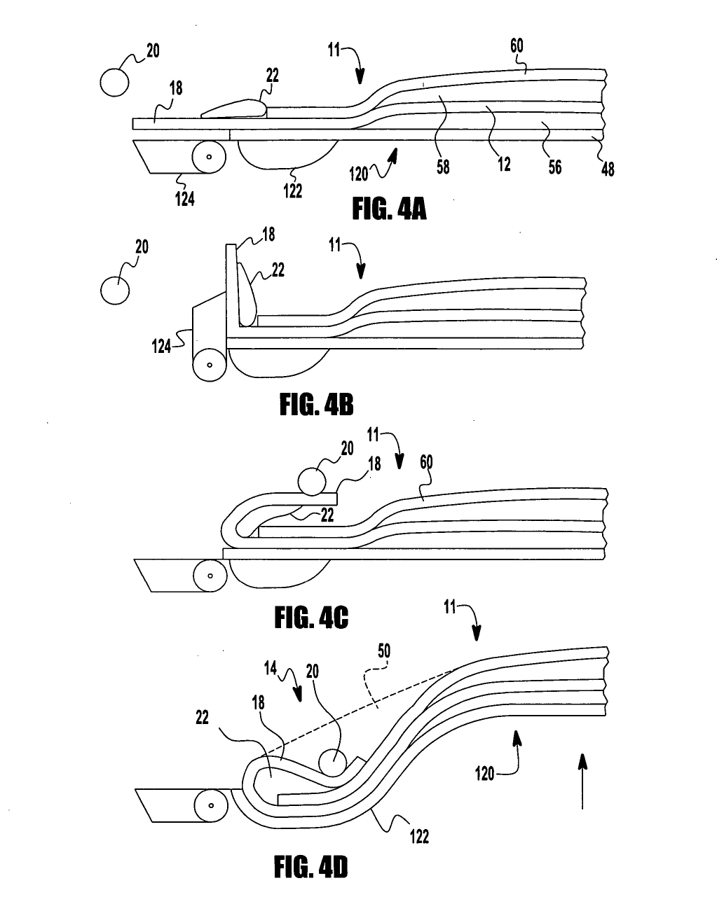

FIGS. 4A-4D illustrate exemplary tire building operations that occur on the tire building drum 120 immediately before application of the apex 50, given the subject exemplary run flat tire 10 construction that is shown finished in FIG. 1. The cross-sectional view shows only a portion of one edge of the tire building drum 120 and tire components built thereupon, however the view should be considered representative of the entire circumference of the drum 120 and of an in-process tire carcass 11 edge. In previous tire building operations, the inner liner 48, then the first elongated insert 56, then the carcass reinforcement ply 12, then the second elongated insert 58, and then the short carcass reinforcement ply 60 have all been layered on the tire building drum 120. Also the rubber wedge 22 has been laid on the ends of the reinforcement plies 12, 60.

FIG. 4A shows the bead core 20 being held in a staging position beyond the end of the turnup portion 18 of the carcass reinforcement ply 12. It can be seen that the tire building drum 120 has a circumferential series of flippers 124 and a circumferential recess or pocket 122.

FIG. 4B shows the flipper 124 turning up the turnup portion 18 and the rubber wedge 22.

FIG. 4C shows the inextensible ring of the bead core 20 after it has been pushed axially inward over the edge of the carcass 11, thereby further folding the turnup portion 18 and the rubber wedge 22 over the end of the short carcass reinforcement ply 60.

FIG. 4D shows the bead area 14 after the tire building drum has been expanded radially outward such that the inextensible bead core 20 constricts the bead area 14 components under it into the pocket 122, thereby tightly wrapping the turnup portion 18 around the rubber wedge 22 and locking them in place. The dashed line indicates the area that needs to be filled by the apex 50. It can be seen that this is an irregularly shaped area that may not be completely filled by a cold, preformed, and therefore somewhat stiff, apex 50. Further problems are also likely when the bead area 14 is re-shaped as the tire carcass is expanded into a toroidal shape. Thus it is desirable to address these problems in the interest of producing better quality tires 10. According to the present invention, a novel solution is to apply the apex 50 to the bead area 14 while the apex 50 is still hot and soft immediately after being formed.

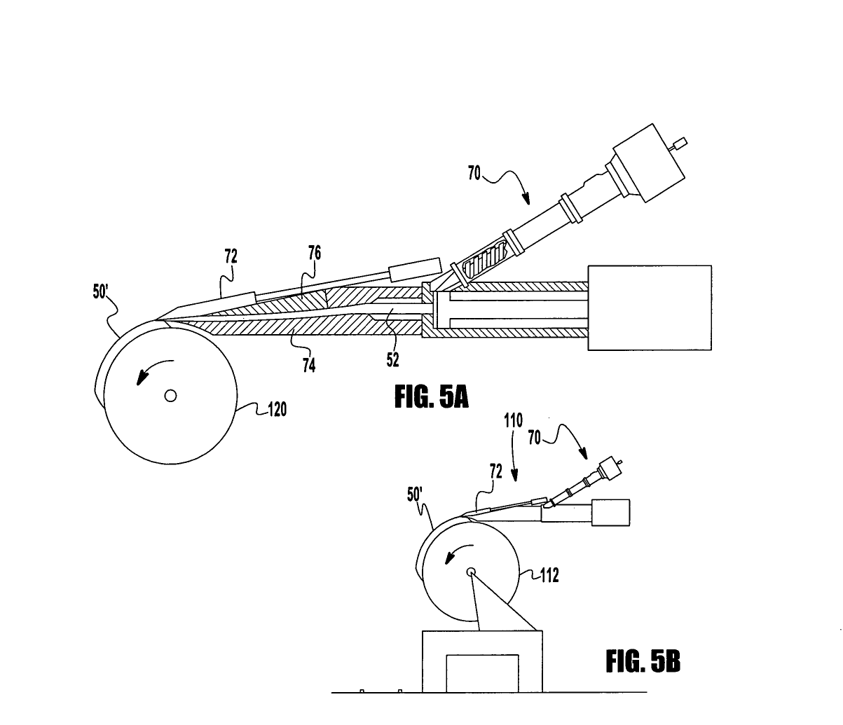

FIG. 5A illustrates an injector-extruder 70 that is configured for extruding hot apex material 52 directly onto a tire building drum 120 (into the bead area 14 of an in-process carcass 11 being built thereupon) to form a hot (and soft) apex 50′ on the tire building drum 120. The hot apex material 52 is injected into a head 74 with an appropriately shaped extrusion die 76.

The tire building drum 120 is rotated in synchrony with the extrusion rate such that the hot apex 50′ is uniformly deposited around the circumference of the tire building drum 120. An ultrasonic guillotine knife 72 can be used to cut off the extruding hot apex material 52 at the desired length of the hot apex 50′.

In high speed automated production systems such as the first stage tire building system 100 described hereinabove, it is desirable to apply the apex 50 quickly, i.e., potentially faster than can be achieved with the injector-extruder 70. Therefore, an alternative embodiment of the invention comprises use of the injector-extruder 70 to extrude the hot apex 50′ onto the application drum 112, immediately before the application process from the application drum 112 to the tire building drum 120 (e.g., as shown in FIG. 3B). FIG. 5B shows the injector-extruder 70 mounted at a work station 110 in place of the conveyor 116 (see FIG. 3A). The application drum 112 is rotated in synchrony with the extrusion rate of the injector-extruder 70 such that the hot apex 50′ is uniformly deposited on the surface of the application drum 112. An ultrasonic guillotine knife 72 can be used to cut off the desired length of the hot apex 50′. This process of extruding the hot apex 50′ on the application drum 112 can be performed at a relatively slow speed such that the hot apex 50′ is accurately positioned on the application drum 112, and is also accurately cut when a predetermined apex length has been deposited on the application drum 112. As shown in FIG. 3B, once the hot apex 50′ has been deposited on the application drum 112, it can be quickly applied (while still hot and soft) to a tire building drum 120 and thereby into the bead area 14 of the in-process carcass 11 being built thereupon.

Although the invention has been illustrated and described in detail in the drawings and foregoing description, the same is to be considered as illustrative and not restrictive in character—it being understood that only preferred embodiments have been shown and described, and that all changes and modifications that come within the spirit of the invention are desired to be protected. Undoubtedly, many other “variations” on the “themes” set forth hereinabove will occur to one having ordinary skill in the art to which the present invention most nearly pertains, and such variations are intended to be within the scope of the invention, as disclosed herein.

What is claimed is:

1. A method for applying an apex at a workstation of a pneumatic tire building machine wherein a carcass reinforcement ply and one or more bead area components have been built into an in-process carcass on a tire building drum of the tire building machine, the method comprising the step of:
extruding hot apex material to form the apex at the workstation.

2. The method of claim 1, further comprising the step of:
extruding into a bead area of the in-process carcass on the tire building drum.

3. The method of claim 2, further comprising the steps of:
firstly laying a carcass reinforcement ply on the tire building drum;
secondly applying a first bead area component that is a rubber wedge;
thirdly wrapping a turnup portion of the carcass reinforcement ply around the rubber wedge;
fourthly applying a second bead area component that is an inextensible bead core onto the turnup portion axially inward of the rubber wedge;
fifthly expanding the tire building drum; and
sixthly performing the extruding step of claim 2.

4. The method of claim 1, further comprising the steps of:
extruding the hot apex material onto an application drum; and
applying a hot apex from the application drum into a bead area of the in-process carcass on the tire building drum.

5. The method of claim 4, further comprising the steps of:
firstly laying a carcass reinforcement ply on the tire building drum;
secondly applying a first bead area component that is a rubber wedge;
thirdly wrapping a turnup portion of the carcass ply around the rubber wedge;
fourthly applying a second bead area component that is an inextensible bead core onto the turnup portion axially inward of the rubber wedge;
fifthly expanding the tire building drum; and
sixthly performing the applying step of claim 4.

6. A tire building machine including a tire building drum, the tire building machine comprising:
an apex-forming injector-extruder for extruding hot apex material.

7. The tire building machine of claim 6 further comprising:
the injector-extruder is configured for extruding hot apex material onto the tire building drum.

8. The tire building machine of claim 6 further comprising:
an application drum configured for transferring a hot apex onto the tire building drum; and wherein:
the injector-extruder is configured for extruding the hot apex onto the application drum.

9. An apex applicator for a first stage tire building machine including a tire building drum at a workstation, the apex applicator comprising:
an apex-forming injector-extruder for extruding hot apex material, wherein the apex applicator is located at the workstation.

10. The apex applicator of claim 9 further comprising:
the injector-extruder is configured for extruding hot apex material onto the tire building drum.

11. The apex applicator of claim 9 comprising:
an application drum configured for transferring a hot apex onto the tire building drum; and wherein:
the injector-extruder is configured for extruding the hot apex onto the application drum.
